(19) United States
(12) Patent Application Publication
(10) Pub. No.: US 2022/0152444 A1
(43) Pub. Date: May 19, 2022

(54) TORQUE FORCE TRAINING SYSTEM

(71) Applicant: Christian Malcolm, Thousand Oaks, CA (US)

(72) Inventor: Christian Malcolm, Thousand Oaks, CA (US)

(21) Appl. No.: 17/528,056

(22) Filed: Nov. 16, 2021

Related U.S. Application Data
(60) Provisional application No. 63/114,482, filed on Nov. 16, 2020.

(51) Int. Cl. A63B 21/072; A61H 7/00; A63B 21/055; A61H 15/00

(52) U.S. Cl. CPC A63B 21/0722; A61H 7/003; A61H 2201/1685; A63B 21/0557; A61H 15/0092; A63B 21/0726

(57) ABSTRACT

Disclosed are example embodiments of for a torque force training system. The torque force training system including a first weighted end collar, a second weighted end collar, a first massage tool, a second massage tool, and a center connecting core configured to connect the first massage tool and the second massage tool, the first massage tool configured to couple to the first weighted end collar and the second massage tool configured to couple to the second weighted end collar. The center connecting core may be coupled to the first massage tool and the second massage tool, the first massage tool opposite the second massage tool. The first massage tool may be coupled to the first weighted end collar and the second massage tool may be coupled to the second weighted end collar.

### CROSS-REFERENCE TO RELATED APPLICATION

This application claims priority to U.S. Provisional Application Ser. No. 63/114,482, filed on Nov. 16, 2020, entitled “TORQUE FORCE TRAINING SYSTEM,” the entire contents of which are hereby incorporated by reference.

The present application is related to U.S. patent application Ser. No. 16/943,962, filed Jul. 30, 2020, International Patent Application No. PCT/US20/44315, filed Jul. 30, 2020, and International Patent Application No. PCT/US19/35886, filed Jun. 6, 2019, which are incorporated herein by reference in their entirety for all purposes.

### FIELD

The present disclosure relates to a training system, and more particularly to a torque force training system.

### BACKGROUND

Sports training and coaching has always been an effective way to teach a philosophy, technique, or an athletic trait to an athlete in order to achieve and maintain physical prowess and success. Across all sports, coaches and trainers instill valuable techniques that enable athletes to move their bodies in response to stimuli or to properly achieve a maximum effort towards a specific goal or feat.

Weights or other resistance training devices are often used by coaches or trainers to create physical exertion levels above and beyond what the body experiences in sports to make the athlete stronger, faster, or more physically fit. However, many athletes need additional specialized tools to absorb the proper technique and or improve athletic form or performance. Muscle memory also plays a key role in the athlete developing proper form or technique during sports. Adjustments or tweaks to an athlete's form or technique is often needed to unleash the true potential of the individual. Tools or techniques that teach positive muscle memory to athletes are becoming increasingly significant factors in achieving success at the highest levels of sports.

Current weights or standard resistance systems may not be as advantageous as originally thought due to the creation of poor muscle memory from torque or improper weight distribution of the tool or device. For example, current dumbbell has been viewed as a great tool for building up strength, speed, and endurance for boxing training; however, on closer examination the weight distribution creates a negative torque on the wrists and elbows resulting in poor form and technique. The use of these current dumbbells can even cause injury to joints and connective tissue over time. The same can be true across many other sports including track and field events, long distance running, golf, hockey, baseball, basketball, football and many other hand and eye coordination sports.

Therefore, there exists a need for handheld weights having one or more massage attachments that may allow for massaging sore or injured muscles.

### SUMMARY

The Torque Force Training system of the present disclosure may combine the previous dumbbell system of torque cable/exercise tension with connecting bars, rope grips, a massage tool system, and bended bars with connective methods. This compete system may be designed as a replacement to all home and gym workout bars including squat bar, lat pull down bar, small row bar, long bicep curl bar, triceps bar, bended triceps bar, rope handle attachments, and a few other combinations of bended connecting bars to complete all functional bar tools currently used within exercises at the gym or at home.

Disclosed are example embodiments of for a torque force training system. The torque force training system including a first weighted end collar, a second weighted end collar, a first massage tool, a second massage tool, and a center connecting core configured to connect the first massage tool and the second massage tool, the first massage tool configured to couple to the first weighted end collar and the second massage tool configured to couple to the second weighted end collar.

Disclosed are example embodiments of for a torque force training system. The torque force training system includes a first center connecting core, a second center connecting core, a third connecting core, the first center connecting core configured to be coupled to the second center connecting core through the third connecting core, and an exercise band configured to be coupled to the first center connecting core and the second center connecting core.

### BRIEF DESCRIPTION OF THE DRAWINGS

FIG. 1 illustrates an exemplary assembled dumbbell of the Torque Force Training system as well as the massage tools in accordance with some embodiments of the systems and methods described herein.

FIG. 2 illustrates how the end collar of the exemplary dumbbell may be easily decoupled from the center core and then attached to either of the additional massage tools to create a handle grip or a massage tool itself in accordance with some embodiments of the systems and methods described herein.

FIG. 3 illustrates exemplary components of the massage tool in accordance with some embodiments of the systems and methods described herein.

FIG. 4 illustrates the knob massage tool coupled with the dumbbell collar to make one tool, in accordance with some embodiments of the systems and methods described herein.

FIG. 5 illustrates the pinpoint massage tool coupled with the dumbbell collar to make one tool, in accordance with some embodiments of the systems and methods described herein.

FIG. 6 illustrates a complete assembled dumbbell with a right weighted collar and a left weighted collar and massage tools, in accordance with some embodiments of the systems and methods described herein.

FIG. 7 illustrates how the dumbbell's end collar may be decoupled to allow for them to be connected by a center bar to form a short bar, in accordance with some embodiments of the systems and methods described herein.

FIG. 8 illustrates exemplary components of a short bar connected to form a short exercise bar, in accordance with some embodiments of the systems and methods described herein.

FIG. 9 illustrates aspects of the short bar and an additional core placed at the center, and two long connecting cores in accordance with some embodiments of the systems and methods described herein.

FIG. 10 illustrates one exemplary detailed connection example of at least the dozen plus potential connections and intensity locations in accordance with some embodiments of the systems and methods described herein.

FIGS. 11 and 12 illustrate additional potential tool possibilities and tension/intensity locations in accordance with some embodiments of the systems and methods described herein.

FIGS. 13 and 14, illustrate multiple areas to add swivel hooks to attach a cable or band to a dumbbell or kettlebell in accordance with some embodiments of the systems and methods described herein.

FIGS. 15A-15B illustrate wrapping bands around a kettlebell.

FIG. 16 illustrates wrapping bands around a kettlebell.

FIG. 17 illustrates wrapping bands around a kettlebell.

### DETAILED DESCRIPTION

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Some handheld weight units were previously described in related applications, such as U.S. patent application Ser. No. 15/188,048 filed Jun. 21, 2016, U.S. Patent Application No. 62/682,707 filed Jun. 8, 2018, U.S. patent application Ser. No. 16/943,962 filed Jul. 30, 2020, PCT Patent Application No. PCT/US20/44315 filed Jul. 30, 2020, and PCT Patent Application No. PCT/US19/35886, filed Jun. 6, 2019, the entire contents and disclosures of which are hereby incorporated by reference.

As described above, the Torque Force Training system of the present disclosure may combine the previous dumbbell system of torque cable/exercise tension with connecting bars, rope grips, a massage tool system, and bended bars with connective methods. This compete system may be designed as a replacement to all home and gym workout bars including squat bar, lat pull down bar, small row bar, long bicep curl bar, triceps bar, bended triceps bar, rope handle attachments, and a few other combinations of bended connecting bars to complete all functional bar tools currently used within exercises at the gym or at home.

The system may provide users with a complete system that can be taken to the gym for assembly when needed and not to rely on gym equipment used by other gym members. In addition to the modular system, a series of connectivity sites or locations, shown in the figures as female threads for example, may be placed on the connecting bar to add addition torque generating tension not offered by traditional linear plane exercises. For example, a torque force squat long bar with swivel hooks at each end can be connected to a cable machine but can also have tension added to the middle of the bar which ads tension from both forward and backward during the squat exercise. This adds a new level of intensity and force applied to the exercise requiring additional muscular exertion.

The drawings will help identify some unlimiting exemplary configurations within the modular Torque Force Training system.

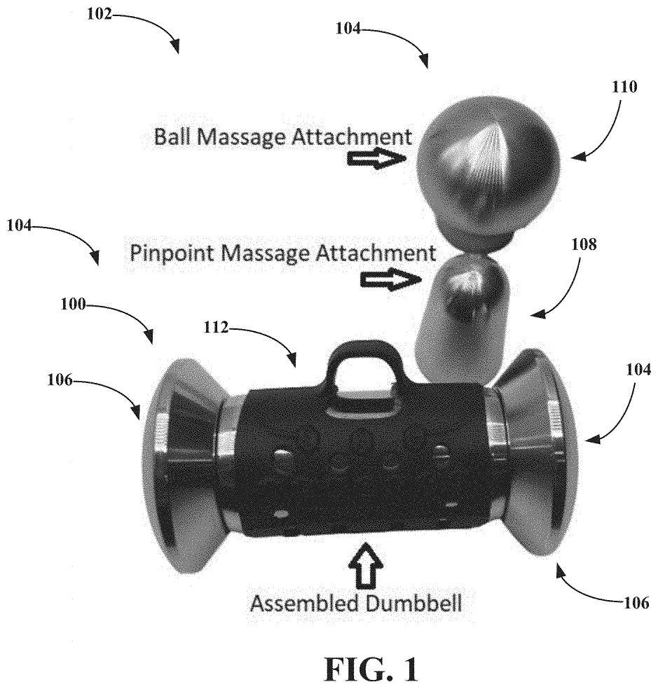

FIG. 1 illustrates an exemplary assembled dumbbell 100 of the Torque Force Training system 102 as well as the massage tools 104 of the Torque Force Training system 102 in accordance with some embodiments of the systems and methods described herein. The Torque Force Training system 102 is the first set of exercise tools, e.g., the exemplary assembled dumbbell 100, and massage tools 104 combined into one complete modular system, e.g., the Torque Force Training system 102. Users of the Torque Force Training system 102 may not only use the assembled tools (e.g., the assembled dumbbell 100 and massage tools 104) to workout but may also massage their muscles after a quick decoupling of some components. For example, the massage tools 104 of the Torque Force Training system 102 may be decoupled from the exemplary assembled dumbbell 100 to allow users to massage their muscles, e.g., after a workout. Illustrated is the exemplary assembled dumbbell 100 which, in the illustrated example, includes two end collars 106 that may also double as a flat press massager (e.g., which may form part of the massage tools 104), and double as a fascia scarper, as well as two additional shapes pictured for massage (e.g., using massage tools 104 such as pinpoint 108 and ball/knob 110).

In some example embodiments, the Torque Force Training system 102 may include various components that may be attached together as described herein. For example, in some example embodiments, the Torque Force Training system 102 may include subsets of various components that may be attached together. For example, a subset of the components from the example dumbbell 100 may be attached to one or more of the pinpoint 108 or ball/knob 110, while not all components from the example dumbbell 100 may be attached to one or more of the pinpoint 108 or ball/knob 110. In one example, the end collars 106 may be attached to the pinpoint 108 or ball/knob 110 while the pinpoint 108 or ball/knob 110 might not attach to the center connecting core 112 of the example dumbbell 100. In an example, the pinpoint 108 or ball/knob 110, and the center connecting core 112 may all have female threads 302. Accordingly, the pinpoint 108 or ball/knob 110, and the center connecting core 112 may not be configured to be connected. In another embodiment, however, a double-sided stud might be used so that one or more of the pinpoint 108 or ball/knob 110, and the center connecting core 112 might be connected together. In yet another embodiment, however, one or more of the pinpoint 108 or ball/knob 110, and the center connecting core 112 might have female threads and another one or more of the pinpoint 108 or ball/knob 110, and the center connecting core 112 might have male threads such that various of these components may be connected together. (It will be understood that the figures only illustrate one example configuration. Other configurations are possible.)

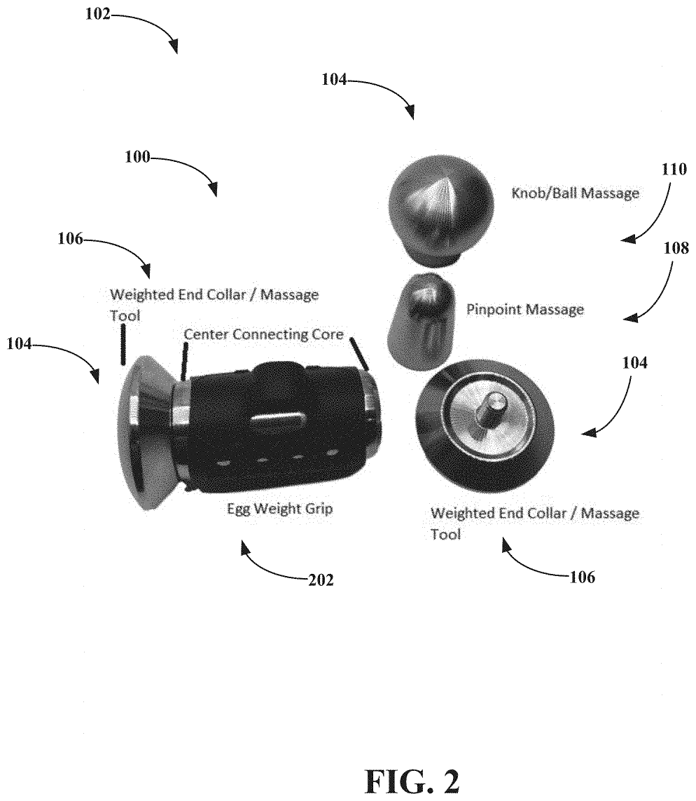

FIG. 2 illustrates how the end collars 106 of the exemplary dumbbell 100 may be easily decoupled from the center core 202 and then attached to either of the additional massage tools (e.g., the pinpoint 108 and the ball/knob 110) to create a handle grip or a massage tool 104 itself in accordance with some embodiments of the systems and methods described herein. Having the ability to decouple one piece of the massage tool 104 not only creates more types of tools, but also allows the user to put one piece in the freezer to make the desired tool cold for therapy but also keeps the handle at room temperature.

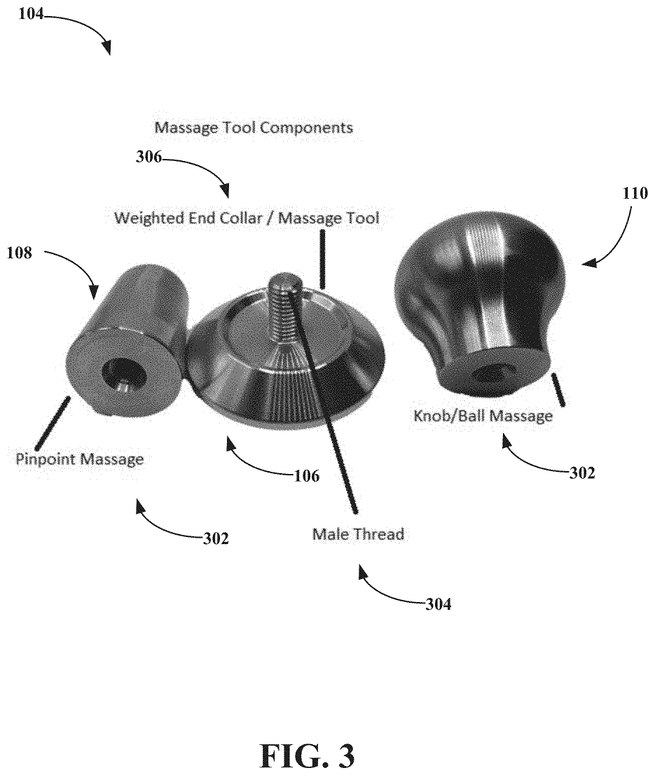

FIG. 3 illustrates exemplary components of the massage tool 104 in accordance with some embodiments of the systems and methods described herein. Pictured is a female thread 302 and male thread 304 to connect the parts 306; however, many alternative coupling solutions may be used as well, such as other fasteners, including, but not limited to pressure fit couplings, pins, cotter pins, hook and loop material, tape, wire, or other fasteners. The embodiments are not limited to the shape and size of the massage tools, as many more shapes and sizes may be designed and developed to meet the needs of a particular user or groups or users. Some example embodiments may include, but are not limited to a longer pinpoint tool, e.g., longer than pinpoint massager 108 to reach the psoas muscle, or two ball attachments as one piece with a rotatory wheel so that the weighted balls may be rolled over the body. In one example embodiment, the end collars 106 of the dumbbell may double as the massage base handle and the scraper tool. In addition, separating the components may allow for separation to allow for hot and cold therapeutic massage. Additional different metals and materials may be used to make up the shape and harness of the desired tool, other than the stainless steel used in the illustrated embodiment.

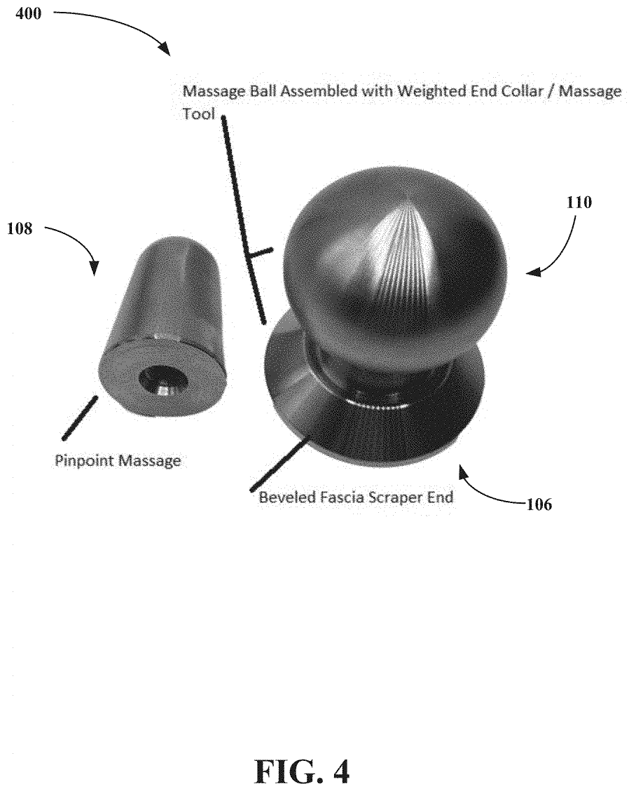

FIG. 4 illustrates the knob massage tool 110 coupled with the dumbbell collar 106 to make one tool 400, in accordance with some embodiments of the systems and methods described herein. The pinpoint massager 108 is also illustrated. The knob massage tool 110 may be coupled with the dumbbell collar 106 to make one tool using the male threads 304 of the dumbbell collar 106 (FIG. 3) and the female threads 302 of the knob massage tool 110 (FIG. 3). In another example embodiment, the male threads and the female threads may be swapped. In other words, the male threads may be part of the knob massage tool 110 and the female threads may be part of the dumbbell collar 106. As described above, embodiments are not limited to a particular fastener, however,

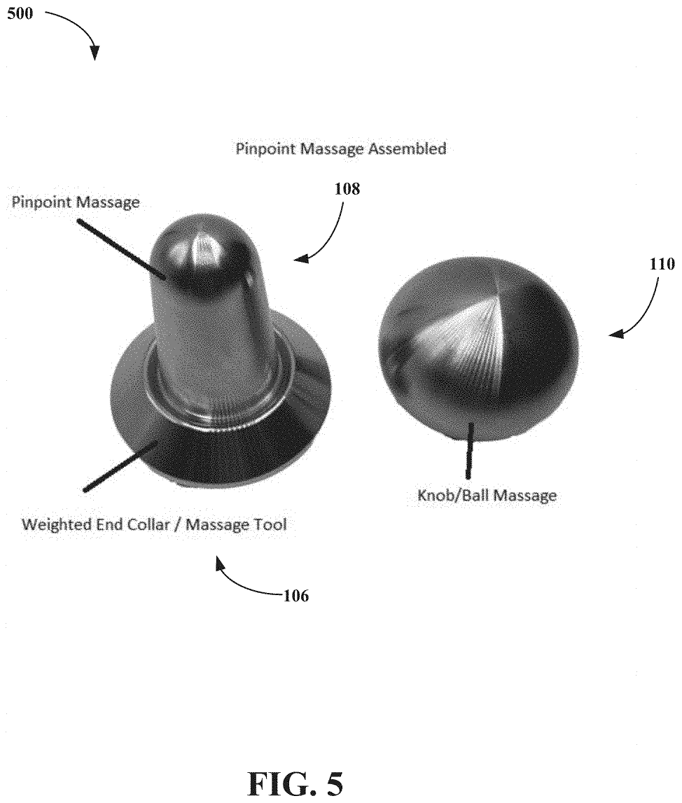

FIG. 5 illustrates the pinpoint massage tool 108 coupled with the dumbbell collar 106 to make one tool 500, in accordance with some embodiments of the systems and methods described herein. The knob massage tool 110 is also illustrated. The pinpoint massage tool 108 may be coupled with the dumbbell collar 106 to make one tool using the male threads 304 of the dumbbell collar 106 (FIG. 3) and the female threads 302 of the pinpoint massage tool 108 (FIG. 3). Again, in another example embodiment, the male threads and the female threads may be swapped. In other words, the male threads may be part of the pinpoint massage tool 108 and the female threads may be part of the dumbbell collar 106. As described above, embodiments are not limited to a particular fastener, however,

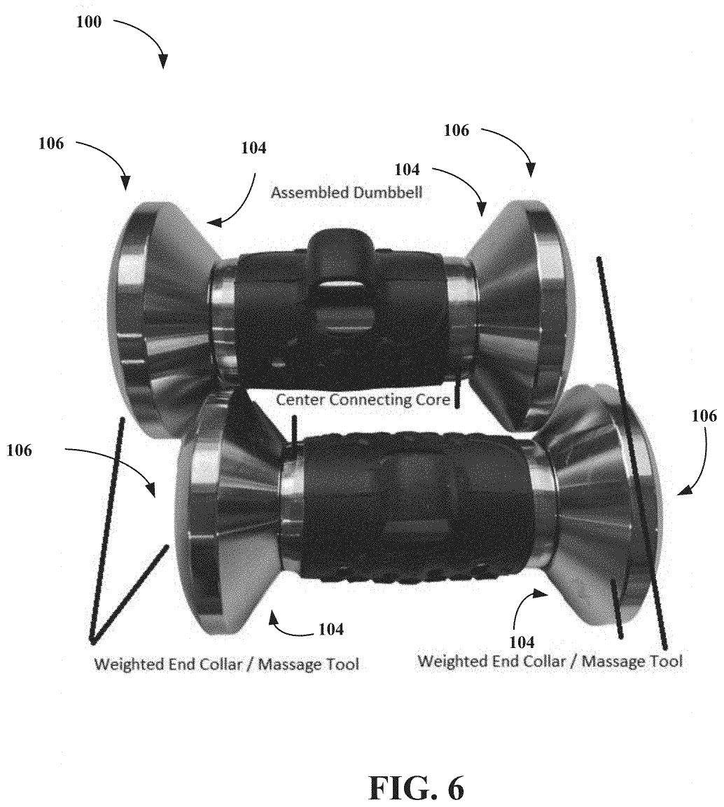

FIG. 6 illustrates a complete exemplary assembled dumbbells 100 of the Torque Force Training system 102 with a right weighted collar (e.g., dumbbell collar 106) and a left weighted collar (e.g., dumbbell collar 106) and massage tools 104, in accordance with some embodiments of the systems and methods described herein. Center connecting core 502 is also illustrated connecting the right weighted collar (e.g., dumbbell collar 106) and the left weighted collar (e.g., dumbbell collar 106). In an example embodiment, the dumbbell collar 106 and massage tools 104 may be formed from separate pieces. In another example embodiment, the dumbbell collar 106 and massage tools 104 may be the same component, e.g., the dumbbell collar 106 and massage tools 104 may be formed from a single piece.

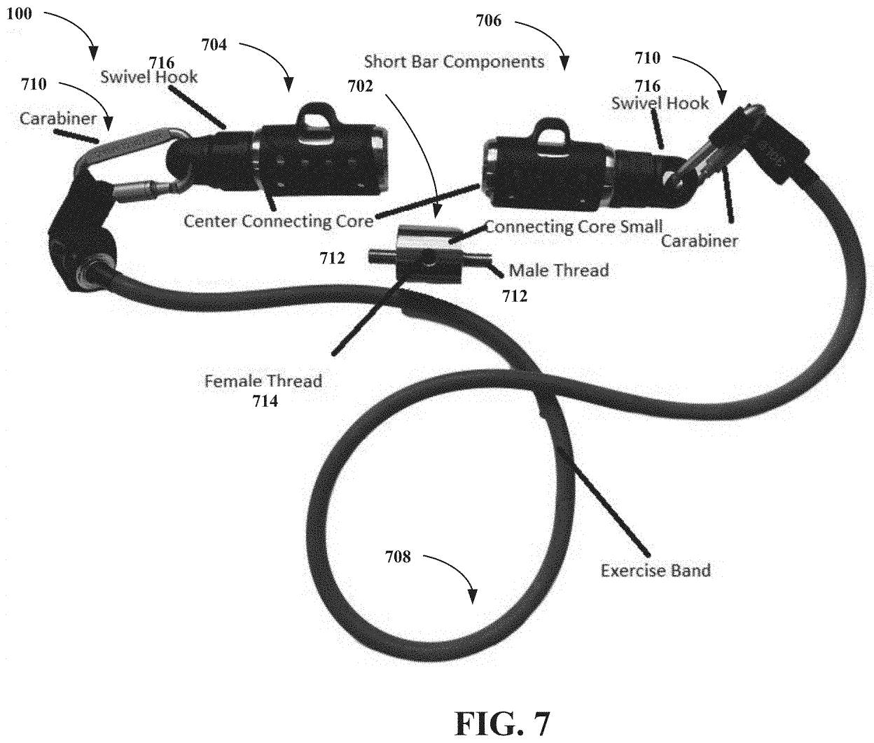

FIG. 7 illustrates the system 700 and how the dumbbell's (e.g., dumbbells 100 of FIGS. 1-6) end collar (e.g., dumbbell collar 106 of FIGS. 1-6) may be decoupled to allow for the end collars to be connected by a center bar 702 to form a short bar, in accordance with some embodiments of the systems and methods described herein. In the illustrated example, the center bar 702 includes male threads 712 opposite each other and female center threads 714.

In the example of FIG. 7, the torque force training system 700 may include a first center connecting core 704 and a second center connecting core 706. The torque force training system 700 may include a third connecting core, e.g., the center bar 702. The first center connecting core 704 may be configured to be coupled to the second center connecting core 706 through the third connecting core 702, e.g., “connecting core small.” Additionally, an exercise band 708 may be configured to be coupled to the first center connecting core 704 and the second center connecting core 706. For example, the exercise band 708 may be coupled to the first center connecting core 704 and the second center connecting core 706 using carabiners 710, e.g., using swivel hooks 716.

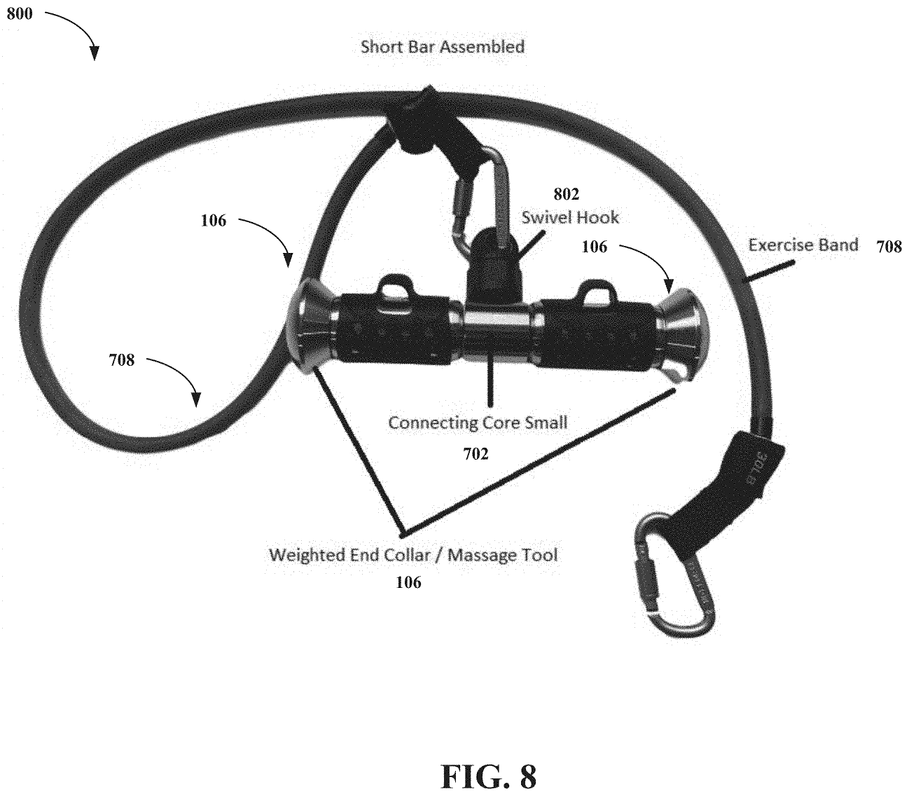

FIG. 8 illustrates exemplary components of a short bar connected to form a short exercise bar 800, in accordance with some embodiments of the systems and methods described herein. Pictured is the short bar 800 configured with two weighted dumbbell collars 106 and a center swivel hook 802 for tension. The center swivel hook 802 may rotate to support fluid motion of the bar in any direction unlike hooks that are part of the bar or restricted in motion. Not pictured are other options, but not limited to, such as swivel hooks on the ends rather than the end collars adding torque from 3 directions (e.g., right, left, and center). In addition, not pictured, any one of the swivel hooks may be replaced with weighted collars to add weight at the end or center of the bar. The components may also include, not pictured, a small rope handle with a coupling feature to remove the metal bar handles and replace it with a thick grip rope for more instability but increase mobility of motion. As illustrated in FIG. 8, the two weighted dumbbells may form a handle for use with the exercise band 708.

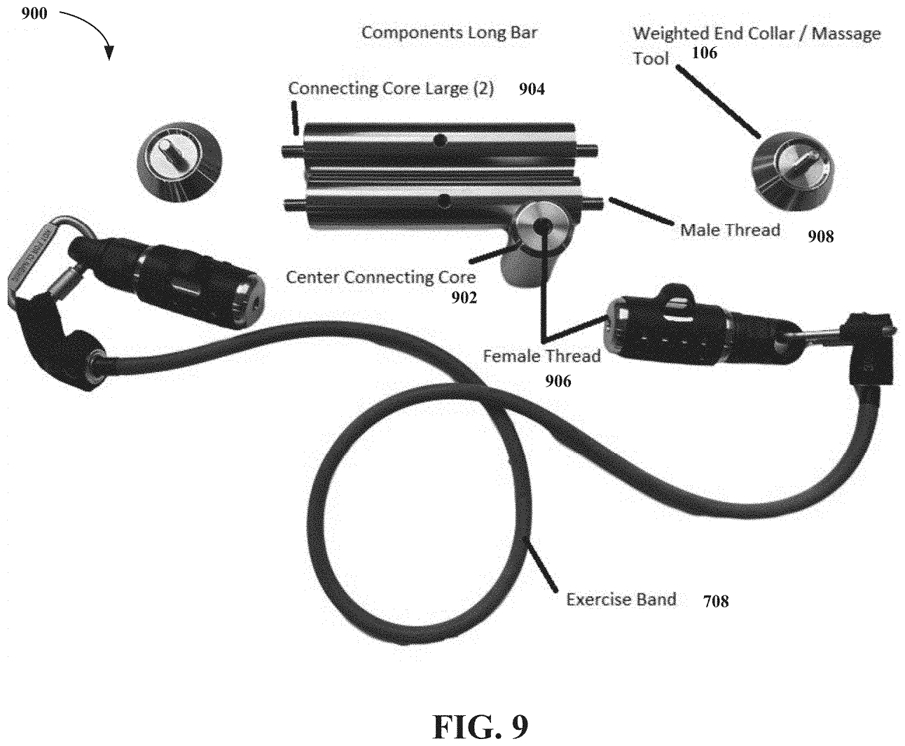

FIG. 9 illustrates component 900 for a long bar including aspects of the short bar and an additional core 902, placed at the center, and two long connecting cores 904 in accordance with some embodiments of the systems and methods described herein. Each connecting core has a connecting location for additional torque or weighted collar to add tension and intensity at any desired location. The connecting locations, identified here as a female thread 906 on the core 902, are lined up to provide even and balanced locations for cable or band attachments. In the illustrated embodiment, the two long connecting cores 904 have male threads 908. It will be understood that in another embodiment, the thread types could be swapped between an additional core 902, placed at the center, and two long connecting cores 904

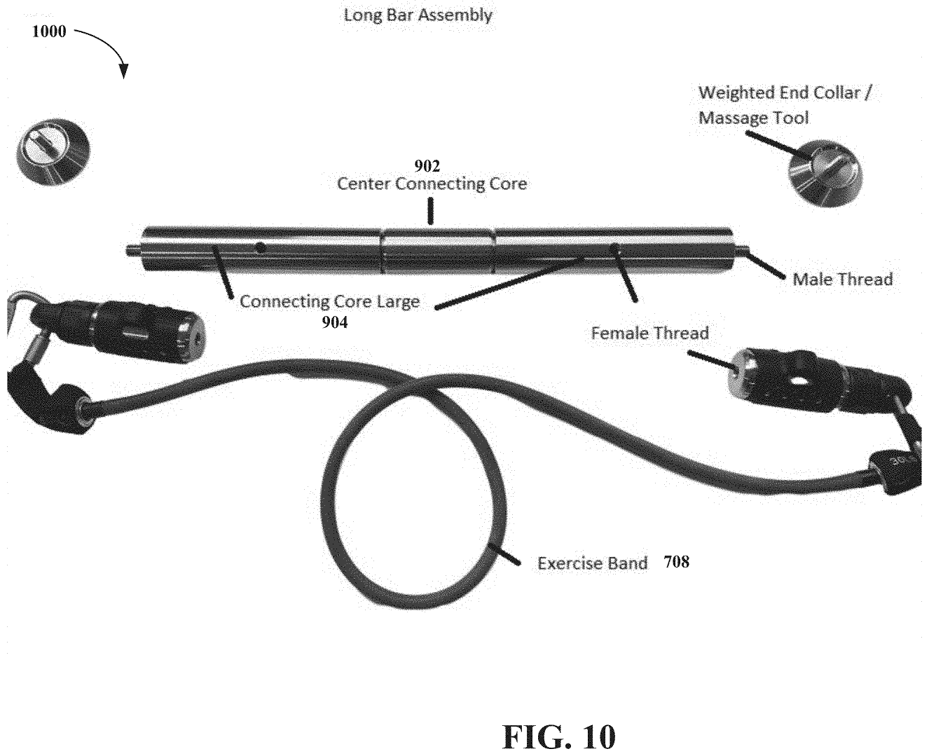

FIG. 10 illustrates a long bar assembly 1000 in one exemplary detailed connection example of at least the dozen plus potential connections and intensity locations in accordance with some embodiments of the systems and methods described herein. The figure also illustrates an exercise band, but in some embodiments, this tension could be created by attaching a cable or additional weight.

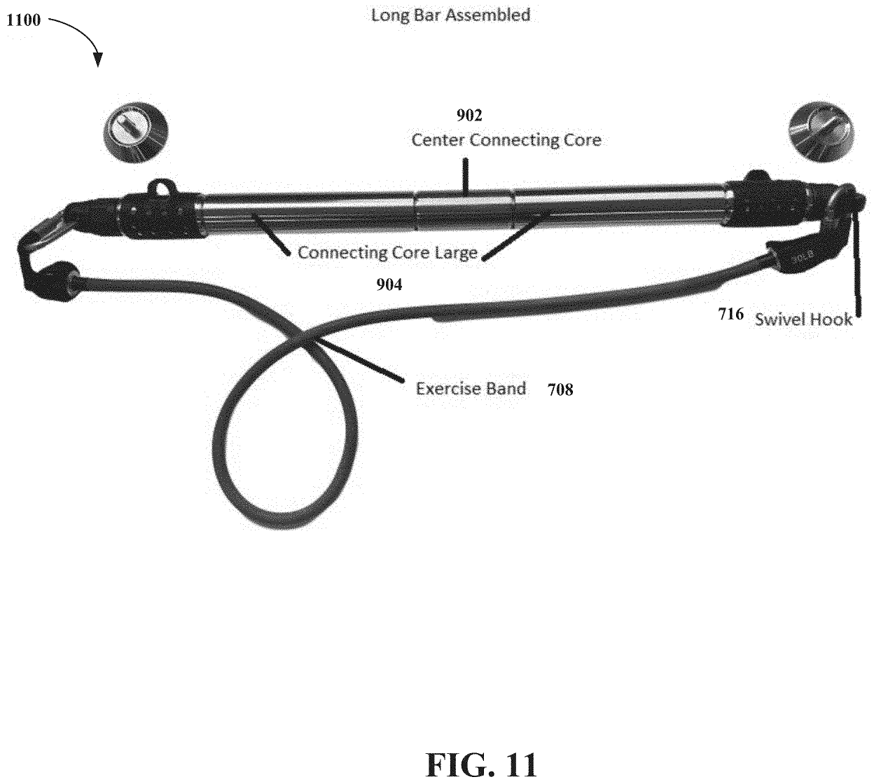

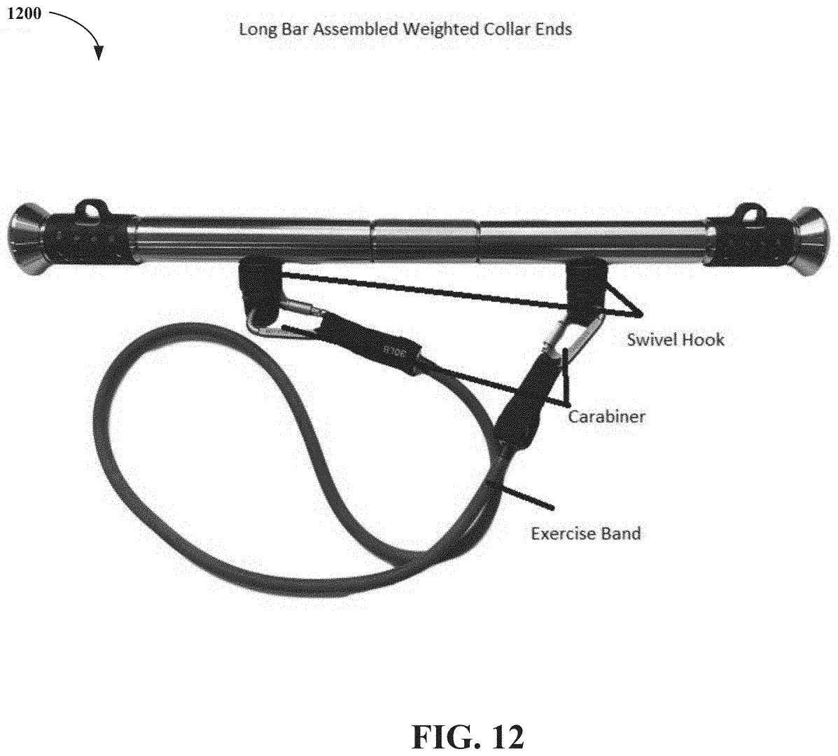

FIGS. 11 and 12 illustrate additional potential tool possibilities 1100, 1200 and tension/intensity locations in accordance with some embodiments of the systems and methods described herein. FIGS. 11 and 12 show additional potential tool possibilities and tension/intensity locations. It may be important to provide alternative tension torque when performing the same exercise or motion to stress the body and muscular skeleton from different angles. This ability to target or isolate certain fluid motion exercises or rough aggressive motions can add tension and intensity from non-linear locations to best mimic real sports movements and intensities. For example, a tennis player has many swings to hit an oncoming ball; however, traditional linear exercises like bicep curls or triceps extensions do not mimic any of the potential swing techniques. The Torque Force Training system can mimic sports movements more closely and apply appropriate tension and intensity to strengthen muscles and soft connective tissue of an athlete.

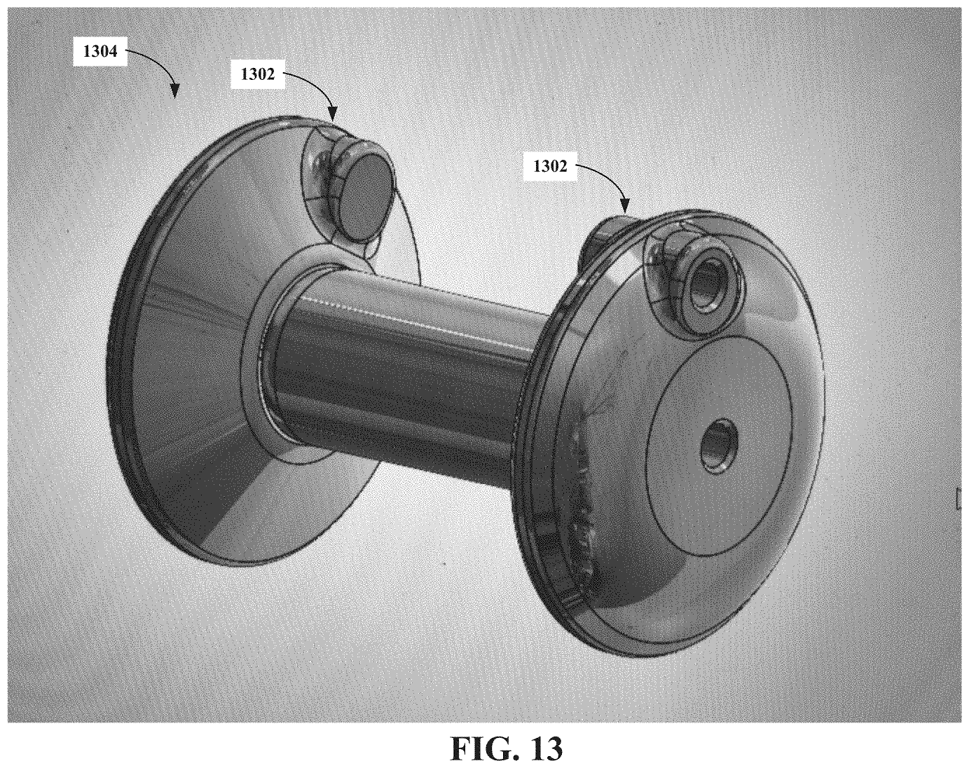

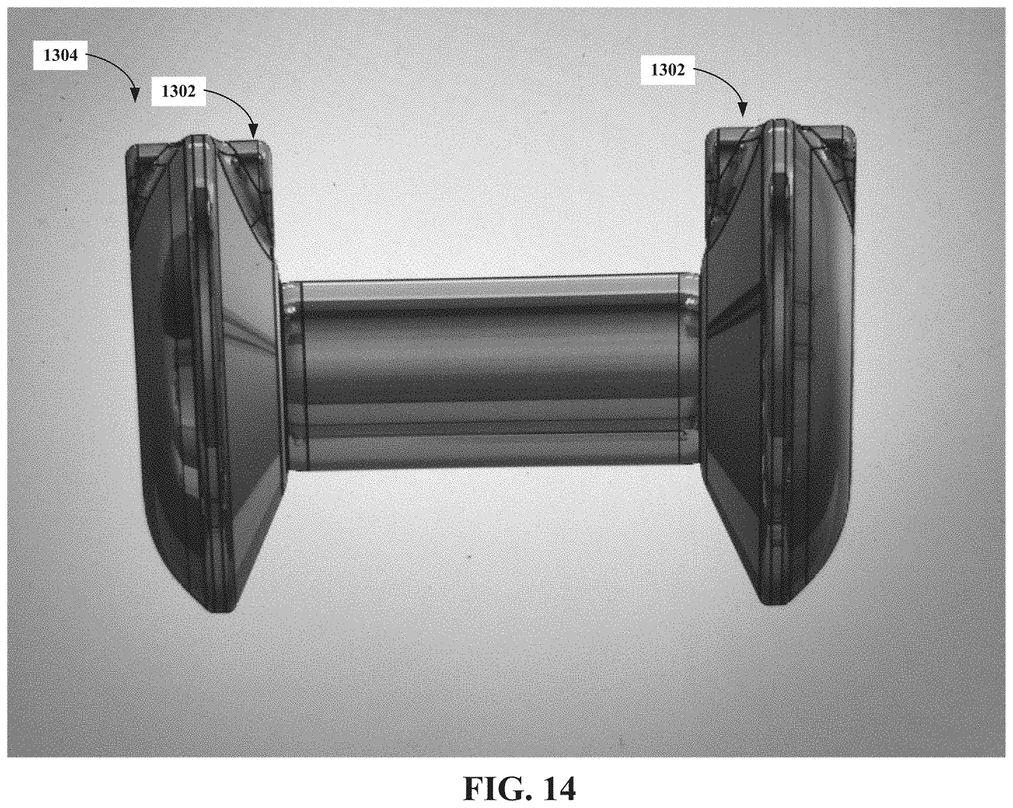

FIGS. 13 and 14, illustrate multiple areas 1302 to add swivel hooks to attach a cable or band to a dumbbell 1304 or kettlebell in accordance with some embodiments of the systems and methods described herein. Referring now to FIGS. 13 and 14, there are multiple areas 1302 to add swivel hooks to attach a cable or band to the dumbbell 1304 or kettlebell. Having different cable attachment zones means a user may have alternative torque or intensity directions rather than just linear Up, Down, side to side, or other directions of motion. In the illustrated example of FIGS. 13 and 14, a user may have 2 points of directional torque, but the user may not want to be limited in scope to just 2 directional intensities, but rather a multitude of directions that may mimic the desired movement or exercise.

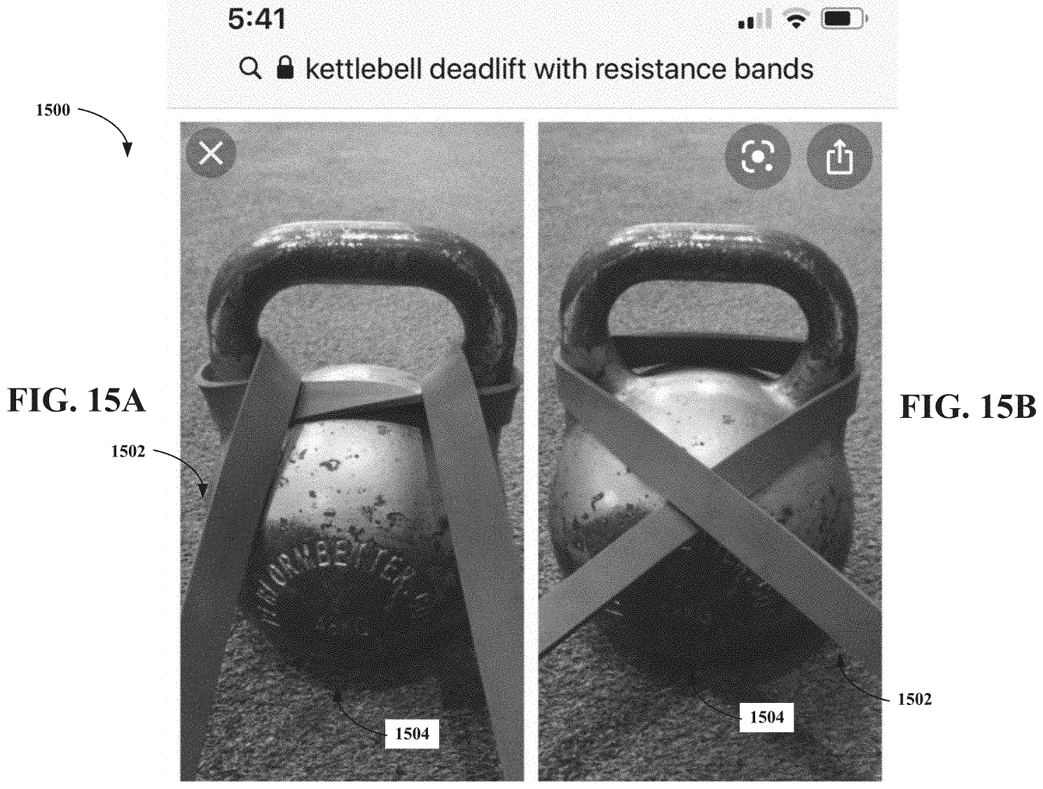

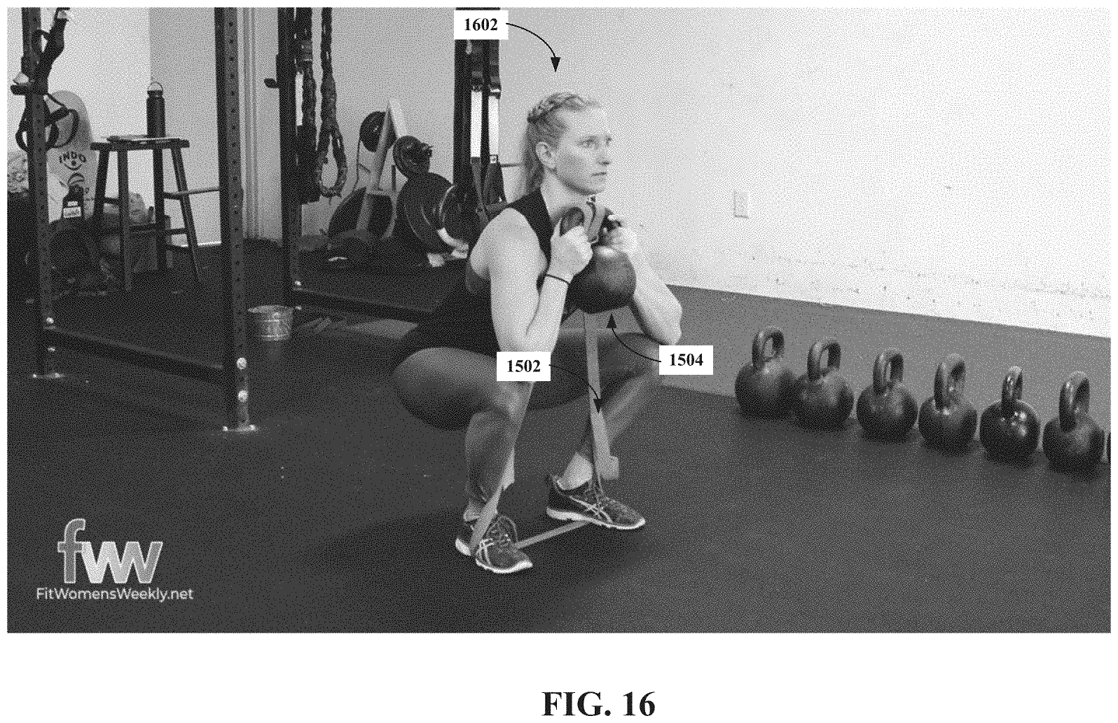

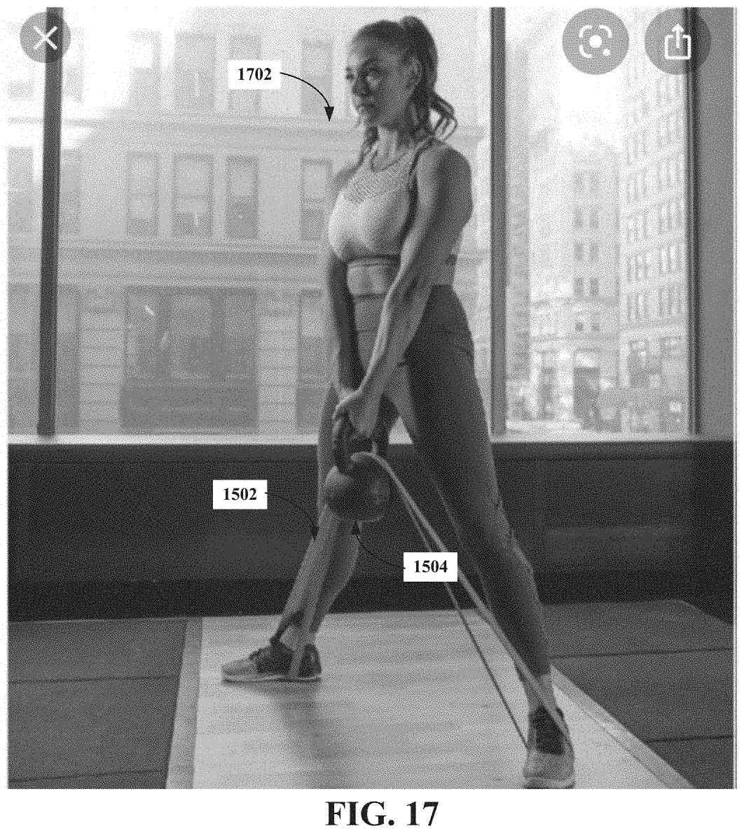

FIGS. 15A-15B illustrate examples 1500 of wrapping bands 1502 around a kettlebell 1504. The bands 1502 and the kettlebell 1504 may be used for a kettlebell deadlift with resistance. FIG. 16 illustrates wrapping bands around a kettlebell. As discussed with respect to FIGS. 15A-15B, the bands 1502 and the kettlebell 1504 may be used for a kettlebell deadlift with resistance. FIG. 16 illustrates a woman 1602 performing a kettlebell deadlift with resistance using a kettlebell 1504 and bands 1502. FIG. 17 illustrates wrapping bands 1502 around a kettlebell 1504. FIG. 17 illustrates another woman 1702 performing a kettlebell deadlift with resistance using a kettlebell 1504 and bands 1502.

The system described herein may eliminate the need to wrap bands around a dumbbell or kettlebell as illustrated in FIGS. 15A to 17. The system described herein may also provide a continuous smooth range of motion. On the contrary, the bands, e.g., illustrated in FIGS. 15A-17 may slip off of the dumbbell or kettlebell that the bands may be wrapped around, move on the dumbbell or kettlebell that the bands may be wrapped around during the exercise or pinch against the hand during exercises. For example, in the illustrated examples of FIGS. 15A to 17, pictured the bands may only go one direction towards or away from the athlete. The system of the present disclosure may have attachment zones on the front of the kettlebell, the back of the kettlebell, and the side of the kettlebell for all directions of intensity desired. In sports movements the speed and explosiveness of the deceleration of movement may be as important as the speed and explosiveness of acceleration.

In some embodiments, the system may include a cage, board, platform, platform with adjustable arms, machine etc., that the athlete can affix the cable or band and anchor it to create directional intensity. The platform or machine may also contain intensity wheels, gears, air pressure or weighted plates to create intensity and torque. The athlete may affix the band or cable to the desired directional intensity and then adjust the weight, pressure or intensity up or down to increase or decrease directional intensity.

In some embodiments, the system may include medicine balls. In some embodiments, the system may include a ball that has bands, so it bounces back up or comes back when you throw it.

In some embodiments, the system may include or support fitness products with added torque.

The above exemplary embodiments illustrate exemplary components and assemblies that may releasably connect to the training system. The configuration of the training system and assemblies is advantageously flexible.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In an aspect, a torque force training system may include a first weighted end collar, a second weighted end collar, a first massage tool, a second massage tool, and a center connecting core configured to connect the first massage tool and the second massage tool, the first massage tool configured to couple to the first weighted end collar and the second massage tool configured to couple to the second weighted end collar.

In an aspect, the torque force training system may include a center connecting core that may be coupled to the first massage tool and the second massage tool. The first massage tool may be opposite the second massage tool.

In an aspect, the torque force training system may include a first massage tool coupled to the first weighted end collar and the second massage tool coupled to the second weighted end collar.

In an aspect, the torque force training system may include a first massage tool and a first weighted end collar, and a second massage tool and a second weighted end collar that are each separate pieces.

In an aspect, the torque force training system the first massage tool and the first weighted end collar may be formed from a first single piece of material and the second massage tool and the second weighted end collar are formed from a second single piece of material.

In an aspect, the torque force training system may include a pinpoint massager configured to be attached to at least one of the first weighted end collar, the second weighted end collar, the first massage tool, or the second massage tool.

In an aspect, the torque force training system may include a knob massager configured to be attached to at least one of the first weighted end collar, the second weighted end collar, the first massage tool, or the second massage tool.

In an aspect, the torque force training system may include a ball massager configured to be attached to at least one of the first weighted end collar, the second weighted end collar, the first massage tool, or the second massage tool.

In an aspect, the torque force training system may include at least one of the first weighted end collar, the second weighted end collar, the first massage tool, or the second massage tool further comprising a beveled fascia scraper end.

In an aspect, the torque force training system may include at least one of the first weighted end collar or the second weighted end collar coupled to at least one of a pinpoint massage, a knob massage, or a ball massage.

In an aspect, the torque force training system may include at least one area configured to add a swivel hook to attach a cable or band to a dumbbell.

In an aspect, the torque force training system may include a first center connecting core, a second center connecting core, a third connecting core, the first center connecting core configured to be coupled to the second center connecting core through the third connecting core, and an exercise band configured to be coupled to the first center connecting core and the second center connecting core.

In an aspect, the torque force training system may include a first center connecting core that couples to the second center connecting core through the third connecting core.

In an aspect, the torque force training system may include an exercise band that may be coupled to the first center connecting core and the exercise band is coupled to the second center connecting core.

In an aspect, the torque force training system may include a third connecting core that includes male threads at opposite ends of the third connecting core.

In an aspect, the torque force training system may include a third connecting core that includes female threads into the third connecting core at a center of the third connecting core.

In an aspect, the torque force training system may include a first connecting core and a second connecting core that each include female threads at opposite ends.

In an aspect, the exercise band is coupled to the first center connecting core using a first carabiner and the exercise band is coupled to the second center connecting core using a second carabiner.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

1. A torque force training system, comprising:
a first weighted end collar;
a second weighted end collar;
a first massage tool;
a second massage tool; and
a center connecting core configured to connect the first massage tool and the second massage tool, the first massage tool configured to couple to the first weighted end collar and the second massage tool configured to couple to the second weighted end collar.

2. The torque force training system of claim 1, the center connecting core is coupled to the first massage tool and the second massage tool, the first massage tool opposite the second massage tool.

3. The torque force training system of claim 1, the first massage tool coupled to the first weighted end collar and the second massage tool coupled to the second weighted end collar.

4. The torque force training system of claim 1, wherein the first massage tool and the first weighted end collar, and the second massage tool and the second weighted end collar are each separate pieces.

5. The torque force training system of claim 1, wherein the first massage tool and the first weighted end collar are formed from a first single piece of material and the second massage tool and the second weighted end collar are formed from a second single piece of material.

6. The torque force training system of claim 1, further comprising a pinpoint massager configured to be attached to at least one of the first weighted end collar, the second weighted end collar, the first massage tool, or the second massage tool.

7. The torque force training system of claim 1, further comprising a knob massager configured to be attached to at least one of the first weighted end collar, the second weighted end collar, the first massage tool, or the second massage tool.

8. The torque force training system of claim 1, further comprising a ball massager configured to be attached to at least one of the first weighted end collar, the second weighted end collar, the first massage tool, or the second massage tool.

9. The torque force training system of claim 1, at least one of the first weighted end collar, the second weighted end collar, the first massage tool, or the second massage tool further comprising a beveled fascia scraper end.

10. The torque force training system of claim 1, wherein at least one of the first weighted end collar or the second weighted end collar is coupled to at least one of a pinpoint massage, a knob massage, or a ball massage.

11. The torque force training system of claim 1, further comprising at least one area configured to add a swivel hook to attach a cable or band to a dumbbell.

12. A torque force training system, comprising:
a first center connecting core;
a second center connecting core;
a third connecting core, the first center connecting core configured to be coupled to the second center connecting core through the third connecting core; and
an exercise band configured to be coupled to the first center connecting core and the second center connecting core.

13. The torque force training system of claim 12, wherein the first center connecting core couples to the second center connecting core through the third connecting core.

14. The torque force training system of claim 12, wherein the exercise band is coupled to the first center connecting core and the exercise band is coupled to the second center connecting core.

15. The torque force training system of claim 12, wherein the third connecting core includes male threads at opposite ends of the third connecting core.

16. The torque force training system of claim 15, wherein the third connecting core includes female threads into the third connecting core at a center of the third connecting core.

17. The torque force training system of claim 15, wherein the first connecting core and the second connecting core each include female threads at opposite ends.

18. The torque force training system of claim 15, wherein the exercise band is coupled to the first center connecting core using a first carabiner and the exercise band is coupled to the second center connecting core using a second carabiner.
